(19) United States
(12) Patent Application Publication
(10) Pub. No.: US 2021/0046972 A1
(43) Pub. Date: Feb. 18, 2021

(54) STEERING DEVICE

(71) Applicant: SHOWA CORPORATION, Gyoda-shi (JP)

(72) Inventors: Hiroshi FUJITA, Haga-gun (JP); Kazutaka SAITO, Haga-gun (JP)

(73) Assignee: SHOWA CORPORATION, Gyoda-shi (JP)

(21) Appl. No.: 17/088,121

(22) Filed: Nov. 3, 2020

Related U.S. Application Data
(63) Continuation of application No. PCT/JP2018/024878, filed on Jun. 29, 2018.

(51) Int. Cl. B62D 5/04; B62D 6/10

(52) U.S. Cl. CPC B62D 5/0463; B62D 6/10

(57) ABSTRACT

A steering device includes: first and second turning motors each applying a force for moving a rack shaft for turning wheels of a vehicle; and first and second controllers respectively controlling driving of the first and second motors. When driving force of either one of the first and second motors is sufficient as a force to be applied to the rack shaft, either one of the first and second controllers that controls driving of the one of the motors drives the one of the motors and when driving force of the one of the motors is insufficient as a force to be applied to the rack shaft, the other of the controllers drives the other of the motors in addition to driving of the one of the motors.

### CROSS-REFERENCE TO RELATED APPLICATIONS

This application is a continuation of International Application No. PCT/JP2018/024878 filed on Jun. 29, 2018, the content of which is incorporated herein by reference in its entirety. The International Application was published in Japanese on Jan. 2, 2020 as International Publication No. WO/2020/003506 under PCT Article 21(2).

### FILED OF THE INVENTION

The present invention relates to a steering device.

### BACKGROUND OF THE INVENTION

Recently some proposals have been made of using two motors for tuning wheels in a steering device equipped with a steer-by-wire system, in which a steering wheel and wheels are not mechanically connected but mechanically separated.

For example, a device disclosed in Japanese Patent No. 5930058 includes: a steering input mechanism in which an input shaft is rotated by a steering operation by a driver; a turning output mechanism configured to turn a wheel by a rotation of an output shaft; a clutch configured to couple the input shaft and the output shaft such that the input shaft and the output shaft are couplable and decouplable; a first motor capable of providing driving force to the turning output mechanism; a second motor capable of providing driving force to the turning output mechanism; a first control unit configured to control driving of the first motor; a second control unit configured to control driving of the second motor; and a torque detection unit configured to detect a torque of the output shaft, wherein at least the first motor and the torque detection unit are configured as an integrated composite component, and the device includes a two-motor turning control mode in which the clutch is disconnected and rotation angles of the first motor and the second motor are controlled by the first control unit and the second control unit depending on a rotation angle of the input shaft.

### Technical Problem

If a steering device includes multiple motors for turning wheels and these motors are controlled by separate control command values, control interference may occur, which may make it impossible to turn the wheels by a desired angle.

An object of the present invention is to provide a steering device that is capable of suppressing control interference even in a configuration in which the wheels can be turned by use of multiple motors.

### SUMMARY OF THE INVENTION

### Solution to Problem

With the above object in view, an aspect of the present invention is a steering device including: a first motor and a second motor each configured to apply a force for moving a turning shaft for turning wheels of a vehicle; a first controller configured to control driving of the first motor; and a second controller configured to control driving of the second motor, wherein when a driving force of either one of the first motor and the second motor is sufficient as a force to be applied to the turning shaft, either one of the first controller and the second controller that controls driving of the one of the motors drives the one of the motors, and when the driving force of the one of the motors is insufficient as a force to be applied to the turning shaft, the other of the controllers drives the other of the motors in addition to the one of the motors being driven by the one of the controllers.

### Advantageous Effects of Invention

The present invention allows to suppress control interference even in a configuration in which the wheels can be turned by use of multiple motors.

### BRIEF DESCRIPTION OF THE DRAWINGS

FIG. 1 shows a schematic configuration of a steering device 1 according to the first embodiment.

FIG. 2 shows a schematic configuration of a control device 50 according to the first embodiment.

FIG. 3 shows a schematic configuration of a control device 250 according to the second embodiment.

FIG. 4 shows a schematic configuration of a control device 350 according to the third embodiment.

FIG. 5 shows a schematic configuration of a control device 450 according to the third embodiment.

FIG. 6 shows a schematic configuration of a control device 550 according to the third embodiment.

### DETAILED DESCRIPTION OF THE INVENTION

Embodiments of the present invention will be described below in detail with reference to the attached drawings.

### First Embodiment

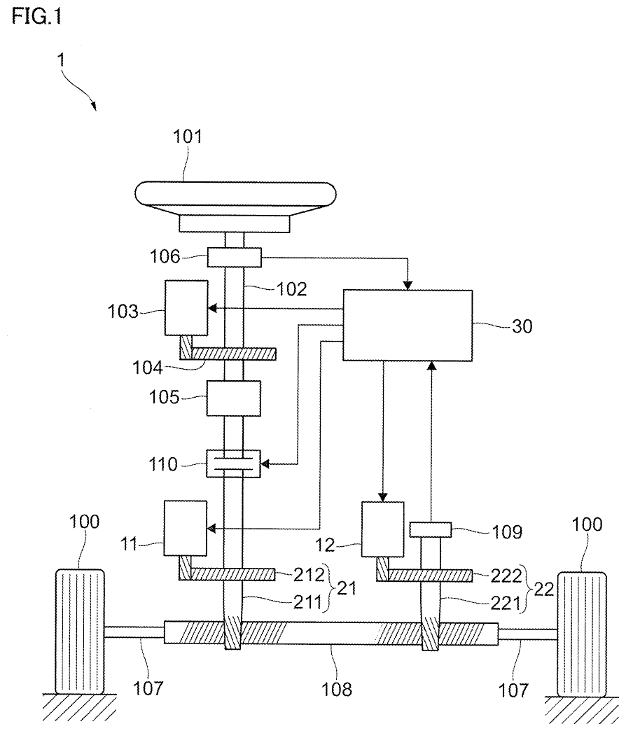

FIG. 1 shows a schematic configuration of a steering device 1 according to the first embodiment.

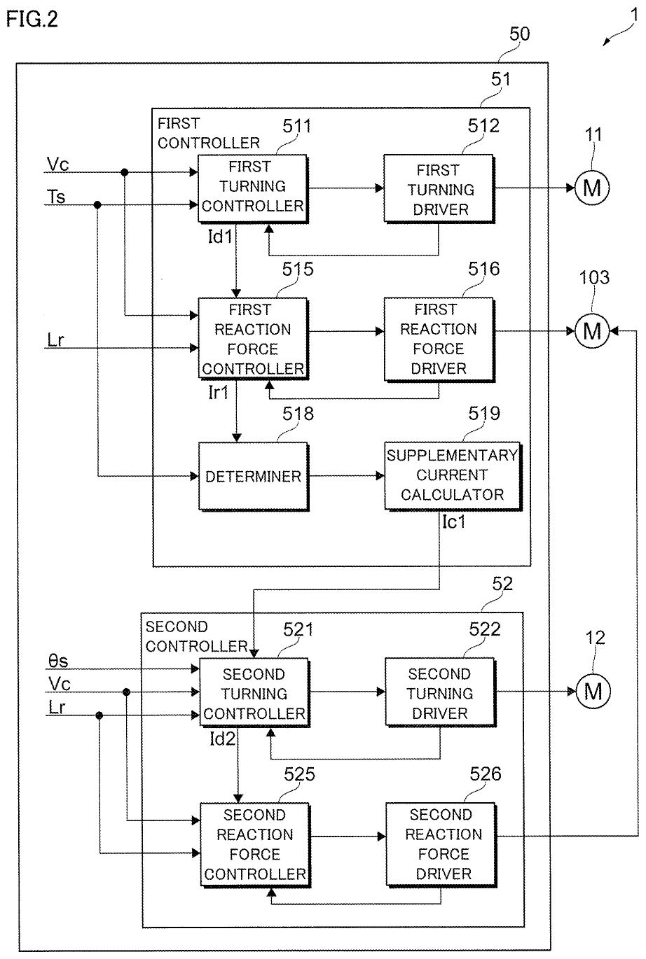

FIG. 2 shows a schematic configuration of a control device 50 according to the first embodiment.

The steering device 1 is an electric power steering device that changes a traveling direction of an automobile as an example of a vehicle by turning front wheels 100 thereof. The steering device 1 is equipped with a so-called steer-by-wire system, in which a wheel-like steering wheel (handle) 101 operated by a driver for changing a traveling direction of the automobile is not mechanically connected to the front wheels 100.

The steering device 1 includes the steering wheel 101 as an example of a steering member operated by the driver and a steering shaft 102 provided integrally with the steering wheel 101. The steering device 1 further includes a reaction force motor 103 that is an electric motor applying steering reaction force to steering of the steering wheel 101, and a gear 104 meshing with a gear mounted on an output shaft of the reaction force motor 103. The steering device 1 further includes a fixing part for fixing the steering shaft 102 at any rotation angle. The steering device 1 further includes a steering detection device 106 for detecting a steering angle θs, which is a rotation angle of the steering wheel 101, and steering torque Ts. The steering detection device 106 detects the steering angle θs on the basis of the rotation angle of the steering shaft 102 and detects the steering torque Ts on the basis of a torsion amount of the steering shaft 102.

The steering device 1 further includes tie rods 107 connected to respective knuckle arms fixed to the respective front wheels 100, and a rack shaft 108 connected to the tie rods 107. The rack shaft 108 is an example of the turning shaft for turning the front wheels 100.

The steering device 1 further includes two motors for driving the rack shaft 108, namely a first turning motor 11 as an example of the first motor and a second turning motor 12 as an example of the second motor. The steering device 1 further includes a first conversion unit 21 for converting rotational driving force of the first turning motor 11 into axial movement of the rack shaft 108, and a second conversion unit 22 for converting rotational driving force of the second turning motor 12 into axial movement of the rack shaft 108.

The first conversion unit 21 includes a first pinion shaft 211 formed with a pinion constituting a rack and pinion mechanism with rack teeth formed on the rack shaft 108, and a first gear 212 mounted on the first pinion shaft 211. The first gear 212 meshes with a gear mounted on an output shaft of the first turning motor 11.

The second conversion unit 22 includes a second pinion shaft 221 formed with a pinion constituting a rack and pinion mechanism with rack teeth formed on the rack shaft 108, and a second gear 222 mounted on the second pinion shaft 221. The second gear 222 meshes with a gear mounted on an output shaft of the second turning motor 12.

The steering device 1 further includes a position detection device 109 for detecting a rack position Lr as a position of the rack shaft 108. By way of example, the position detection device 109 is a device that detects the rack position Lr by detecting a rotation angle of the second pinion shaft 221.

The steering device 1 further includes a clutch 110 that is switchable between a state in which the steering shaft 102 and the first pinion shaft 211 are connected and a state in which the steering shaft 102 and the first pinion shaft 211 are disconnected.

### (Control Device)

The steering device 1 further includes a control device 50 for controlling operation of the first turning motor 11, the second turning motor 12, the reaction force motor 103, and the clutch 110.

The control device 50 includes an arithmetic logic circuit composed of a CPU, a flash ROM, a RAM, a backup RAM, and the like. The control device 50 includes a first controller 51 controlling driving of the first turning motor 11 and the reaction force motor 103, and a second controller 52 capable of controlling driving of the second turning motor 12 and the reaction force motor 103. The first controller 51 and the second controller 52 are capable of switching connection and disconnection of the clutch 110.

The control device 50 receives output signals from the aforementioned steering detection device 106 and output signals from the aforementioned position detection device 109. The control device 50 identifies the steering angle θs and the steering torque Ts on the basis of the output signals from the steering detection device 106. Via a network (CAN) for communication of signals for controlling various apparatuses installed in the automobile, the control device 50 also receives output signals from a vehicle speed sensor that detects a vehicle speed Vc as a moving speed of the automobile. The control device 50 identifies the vehicle speed Vc on the basis of the output signals from the vehicle speed sensor.

In the following description, the sign of the torque that causes the steering shaft 102 to rotate in one rotational direction is defined to be positive, and the sign of the torque that causes the steering shaft 102 to rotate in the other rotational direction is defined to be negative. When the steering wheel 101 is rotated in the one rotational direction, the first controller 51 drives the first turning motor 11 to move the rack shaft 108 in one axial direction and thereby turn the front wheels 100 in the one rotational direction. A flow direction of an electric current supplied to the first turning motor 11 to move the rack shaft 108 in the one axial direction is defined as a positive direction, and a flow direction of an electric current supplied to the first turning motor 11 to move the rack shaft 108 in the other axial direction is defined as a negative direction. Likewise, when the steering wheel 101 is rotated in the one rotational direction, the second controller 52 drives the second turning motor 12 to move the rack shaft 108 in the one axial direction and thereby turn the front wheels 100 in the one rotational direction. A flow direction of an electric current supplied to the second turning motor 12 to move the rack shaft 108 in the one axial direction is defined as a positive direction, and a flow direction of an electric current supplied to the second turning motor 12 to move the rack shaft 108 in the other axial direction is defined as a negative direction. Also, a flow direction of an electric current supplied to the reaction force motor 103 to rotate the reaction force motor 103 and thereby rotate the steering shaft 102 in the one rotational direction is defined as a positive direction, and a flow direction of an electric current supplied to the reaction force motor 103 to rotate the reaction force motor 103 and thereby rotate the steering shaft 102 in the other rotational direction is defined as a negative direction.

### (First Controller)

The first controller 51 includes a first turning controller 511 calculating a control amount by which driving of the first turning motor 11 is controlled, and a first turning driver 512 driving the first turning motor 11 on the basis of the control amount calculated by the first turning controller 511. The first controller 51 further includes a first turning current detector (not shown) detecting an actual current actually flowing in the first turning motor 11.

The first controller 51 further includes a first reaction force controller 515 calculating a control amount by which driving of the reaction force motor 103 is controlled, and a first reaction force driver 516 driving the reaction force motor 103 on the basis of the control amount calculated by the first reaction force controller 515. The first controller 51 further includes a first reaction force current detector (not shown) detecting an actual current actually flowing in the reaction force motor 103.

The first controller 51 further includes a determiner 518 determining whether the driving force of the first turning motor 11 is insufficient to move the rack shaft 108. The first controller 51 further includes a supplementary current calculator 519. When the determiner 518 determines that there is insufficient force to move the rack shaft 108 (hereinafter may also be referred to as “insufficient output”), the supplementary current calculator 519 calculates a supplementary current Ic1 for compensating for the insufficiency of force by the driving force of the second turning motor 12.

The first turning controller 511 sets a first turning current Id1 on the basis of the steering torque Ts and the vehicle speed Vc. The first turning current Id1 is a target current to be supplied to the first turning motor 11. By way of example, at given steering torque Ts, the first turning controller 511 increases the amount of the first turning current Id1 with decrease in the vehicle speed Vc. Also, by way of example, at a given vehicle speed Vc, the first turning controller 511 increases the amount of the first turning current Id1 with increase in the steering torque Ts. The first turning controller 511 may set a dead zone range where the first turning current Id1 is set to zero regardless of the value of the steering torque Ts.

The first turning controller 511 performs feedback control on the basis of deviation between the first turning current Id1 and the actual current detected by the first turning current detector. The first turning controller 511 outputs the control amount calculated by the feedback processing to the first turning driver 512.

By way of example, the first turning driver 512 is an inverter that supplies a power-supply voltage from a battery (not shown) installed in the automobile to the first turning motor 11 and includes, for example, six independent transistors (FETs) as switching elements.

By way of example, the first turning current detector detects a value of an actual current flowing in the first turning motor 11, on the basis of voltages at both ends of a shunt resistor connected to the first turning driver 512.

The first reaction force controller 515 sets a first reaction force current Ir1 on the basis of the rack position Lr, the vehicle speed Vc, and the first turning current Id1. The first reaction force current Ir1 is a target current to be supplied to the reaction force motor 103. The first reaction force controller 515 sets the first reaction force current Ir1 that causes the steering shaft 102 to rotate in a direction corresponding to a moving direction of the rack shaft 108 by an amount corresponding to a moving amount of the rack shaft 108 caused by the driving force of the first turning motor 11. In other words, the first reaction force current Ir1 is a current that causes the reaction force motor 103 to output driving force for eliminating torsion of the steering shaft 102 due to steering of the steering wheel 101, by an amount corresponding to the moving amount of the rack shaft 108 caused by the driving force of the first turning motor 11. Hence, the first reaction force current Ir1 is a current that allows torsion due to a reaction force from a road surface acting on the front wheels 100 to remain in the steering shaft 102, and the reaction force motor 103 serves as the third motor applying reaction force to the steering of the steering wheel 101.

The first reaction force controller 515 estimates the moving amount of the rack shaft 108 according to the first turning current Id1, on the basis of the rack position Lr and the vehicle speed Vc. By way of example, at a given rack position Lr, the first reaction force controller 515 decreases the amount of the first reaction force current Ir1 with decrease in the vehicle speed Vc. Also, by way of example, at a given vehicle speed Vc, the first reaction force controller 515 decreases the amount of the first reaction force current Ir1 with increase in the movement amount of the rack position Lr from a neutral position (the position at which the steering angle of the front wheels 100 is zero).

The first reaction force controller 515 performs feedback control on the basis of deviation between the first reaction force current Ir1 and the actual current detected by the first reaction force current detector. The first reaction force controller 515 outputs the control amount calculated by the feedback processing to the first reaction force driver 516.

By way of example, the first reaction force driver 516 is an inverter that supplies a power-supply voltage from the battery (not shown) installed in the automobile to the reaction force motor 103 and includes, for example, six independent transistors (FETs) as switching elements.

By way of example, the first reaction force current detector detects a value of an actual current flowing in the reaction force motor 103, on the basis of voltages at both ends of a shunt resistor connected to the first reaction force driver 516.

The determiner 581 determines whether there is insufficient output on the basis of the steering torque Ts and the first reaction force current Ir1. The determiner 581 determines that there is insufficient output when the torsion of the steering shaft 102 according to the steering torque Ts is not fully eliminated by rotation of the steering shaft 102 caused by the first reaction force current Ir1. By way of example, when a value obtained by subtracting an absolute value of motor torque Tr1 according to the first reaction force current Ir1 from an absolute value of the steering torque Ts is larger than predetermined torque T0 (|Ts|−|Tr1|>T0), the determiner 581 determines that there is insufficient output.

The supplementary current calculator 519 calculates the supplementary current Ic1 according to a torque difference ΔT1 that is difference between the steering torque Ts and the motor torque Tr1 according to the first reaction force current Ir1. The supplementary current calculator 519 obtains the torque difference ΔT1 by subtracting the motor torque Tr1 from the steering torque Ts (ΔT1=Ts−Tr1), and calculates the supplementary current Ic1 by substituting the obtained torque difference ΔT1 into a control map or a calculation formula defining a relationship between the torque difference ΔT1 and the supplementary current Ic1. By way of example, the control map or the calculation formula may be set such that the supplementary current Ic1 is positive when the torque difference ΔT1 is positive, the supplementary current Ic1 is negative when the torque difference ΔT1 is negative, and an absolute value of the supplementary current Ic1 increases with increase in an absolute value of the torque difference ΔT1.

### (Second Controller)

The second controller 52 includes a second turning controller 521 calculating a control amount by which driving of the second turning motor 12 is controlled, and a second turning driver 522 driving the second turning motor 12 on the basis of the control amount calculated by the second turning controller 521. The second controller 52 further includes a second current detector (not shown) detecting an actual current actually flowing in the second turning motor 12. The second controller 52 further includes a second reaction force controller 525 calculating a control amount by which driving of the reaction force motor 103 is controlled, and a second reaction force driver 526 driving the reaction force motor 103 on the basis of the control amount calculated by the second reaction force controller 525. The second controller 52 further includes a second reaction force current detector (not shown) detecting an actual current actually flowing in the reaction force motor 103.

The second turning controller 521 sets a second turning current Id2 on the basis of the steering angle θs, the vehicle speed Vc, and the rack position Lr. The second turning current Id2 is a target current to be supplied to the second turning motor 12. By way of example, at a given vehicle speed Vc, the second turning controller 521 increases the amount of the second turning current Id2 with increase in a difference between a target rack position Lrt according to the steering angle θs detected by the steering detection device 106 and the rack position Lr detected by the position detection device 109. Also, by way of example, at a given difference between the target rack position Lrt and the rack position Lr, the second turning controller 521 increases the amount of the second turning current Id2 with decrease in the vehicle speed Vc. The second turning controller 521 may set a dead zone range where the second turning current Id2 is set to zero regardless of the difference between the target rack position Lrt and the rack position Lr.

When the second turning controller 521 obtains the supplementary current Ic1 from the supplementary current calculator 519 of the first controller 51, the second turning controller 521 sets the supplementary current Ic1 as the second turning current Id2.

The second turning controller 521 performs feedback control on the basis of deviation between the second turning current Id2 and the actual current detected by the second turning current detector. The second turning controller 521 outputs the control amount calculated by the feedback processing to the second turning driver 522.

By way of example, the second turning driver 522 is an inverter that supplies a power-supply voltage from the battery (not shown) installed in the automobile to the second turning motor 12.

By way of example, the second turning current detector detects a value of an actual current flowing in the second turning motor 12, on the basis of voltages at both ends of a shunt resistor connected to the second turning driver 522.

The second reaction force controller 525 sets a second reaction force current Ir2 on the basis of the rack position Lr, the vehicle speed Vc, and the second turning current Id2. The second reaction force current Ir2 is a target current to be supplied to the reaction force motor 103. The second reaction force controller 525 sets the second reaction force current Ir2 that causes the steering shaft 102 to rotate in a direction corresponding to a moving direction of the rack shaft 108 by an amount corresponding to a moving amount of the rack shaft 108 caused by the driving force of the second turning motor 12. In other words, the second reaction force current Ir2 is a current that causes the reaction force motor 103 to output driving force for rotating a portion of the steering shaft 102 mounted with the gear 104 by a rotation angle corresponding to the moving amount of the rack shaft 108 caused by the driving force of the second turning motor 12.

The second reaction force controller 525 estimates the moving amount of the rack shaft 108 according to the second turning current Id2, on the basis of the rack position Lr and the vehicle speed Vc. By way of example, at a given rack position Lr, the second reaction force controller 525 decreases the amount of the second reaction force current Ir2 with decrease in the vehicle speed Vc. Also, by way of example, at a given vehicle speed Vc, the second reaction force controller 525 decreases the amount of the second reaction force current Ir2 with increase in the movement amount of the rack position Lr from the neutral position.

The second reaction force controller 525 performs feedback control on the basis of deviation between the second reaction force current Ir2 and the actual current detected by the second reaction force current detector. The second reaction force controller 525 outputs the control amount calculated by the feedback processing to the second reaction force driver 526.

By way of example, the second reaction force driver 526 is an inverter that supplies a power-supply voltage from the battery (not shown) installed in the automobile to the reaction force motor 103.

By way of example, the second reaction force current detector detects a value of an actual current flowing in the reaction force motor 103, on the basis of voltages at both ends of a shunt resistor connected to the second reaction force driver 526.

The above configured first controller 51 controls the first turning motor 11 on the basis of the steering torque Ts detected by the steering detection device 106 and controls the reaction force motor 103 on the basis of the first turning current Id1 as the control amount for controlling the first turning motor 11. As such, the first controller 51 controls the first turning motor 11 and the reaction force motor 103 on the basis of the steering torque Ts detected by the steering detection device 106. Also on the basis of the steering torque Ts detected by the steering detection device 106, the first controller 51 determines whether there is insufficient output from the first turning motor 11 and sets the supplementary current Ic1 to be supplied to the second turning motor 12. As such, the first controller 51 sets the control amount for controlling the second turning motor 12 on the basis of the steering torque Ts detected by the steering detection device 106.

Meanwhile, the second controller 52 controls the second turning motor 12 on the basis of the steering angle θs detected by the steering detection device 106 and is capable of controlling the reaction force motor 103 on the basis of the second turning current Id2 as the control amount for controlling the second turning motor 12. As such, the second controller 52 is capable of controlling the second turning motor 12 and the reaction force motor 103 on the basis of the steering angle θs detected by the steering detection device 106.

The above configured steering device 1 according to the first embodiment performs the following control when an operation in which the clutch 110 is controlled so as to disconnect the steering shaft 102 (the steering wheel 101) and the first pinion shaft 211 is in place (hereinafter may be referred to as an “SBW operation”). That is, in a normal state, the steering device 1 performs control such that the first controller 51 drives the first turning motor 11, which is an example of the to-be-controlled motor and is to be controlled by the first controller 51. Specifically, each element of the first controller 51, such as the first turning controller 511, performs each processing described above at predetermined time intervals (e.g., every 1 millisecond). When the driving force of the first turning motor 11 is insufficient as a force to be applied to the rack shaft 108, the second controller 52 in the steering device 1 receives information on the supplementary current Ic1 from the first controller 51 and performs control to drive the second turning motor 12, which is the motor to be controlled by the second controller 52. Specifically, each element of the second controller 52, such as the second turning controller 521, the second turning driver 522, and the second turning current detector, performs each processing when the second controller 52 receives information on the supplementary current Ic1 from the first controller 51. Note that the above “normal state” refers to a state in which the driving force of the first turning motor 11 is sufficient as a force to be applied to the rack shaft 108. The state in which the driving force of the first turning motor 11 is sufficient as a force to be applied to the rack shaft 108 refers to a state in which the rack shaft 108 can be moved by the driving force of the first turning motor 11 such that the front wheels 100 turn by a turning angle according to the steering torque Ts of the steering wheel 101.

In other words, the steering device 1 is configured such that when the driving force of the first turning motor 11, which is one of the first turning motor 11 and the second turning motor 12, is sufficient as a force to be applied to the rack shaft 108, the first controller 51 controlling driving of the first turning motor 11 drives the first turning motor 11. Also, the steering device 1 is configured such that when the driving force of the first turning motor 11 is insufficient as a force to be applied to the rack shaft 108, the second controller 52 drives the second turning motor 12 in addition to driving of the first turning motor 11.

As such, when the driving force of the first turning motor 11 is sufficient as a force to be applied to the rack shaft 108 according to the steering torque Ts, or in other words when the determiner 518 does not determine that there is insufficient output, the steering device 1 according to the first embodiment performs control such that the rack shaft 108 is moved by the driving force of the first turning motor 11 under the control of the first controller 51. On the other hand, when the driving force of the first turning motor 11 is insufficient as a force to be applied to the rack shaft 108, the steering device 1 moves the rack shaft 108 by applying the driving force of the second turning motor 12 thereto in addition to the driving force of the first turning motor 11. This minimizes situations where the front wheels 100 are turned by use of the driving force of both the first turning motor 11 and the second turning motor 12, even though the configuration allows the front wheels 100 to be turned by use of the multiple motors of the first turning motor 11 and the second turning motor 12. This, in turn, suppresses control interference.

The determiner 518 of the first controller 51 determines whether the driving force of the first turning motor 11 is insufficient with reference to the steering torque Ts, which is the basis for the first controller 51 to control the first turning motor 11, and the first reaction force current Ir1. Thus, the steering device 1 according to the first embodiment only activates the first controller 51 when the driving force of the first turning motor 11 can make the front wheels 100 turn by a desired angle. This reduces load on the control device 50.

The configuration in which the driving force of the second turning motor 12 compensates for any insufficient output of the driving force of the first turning motor 11, as used in the steering device 1 according to the present embodiment, allows an output capacity of the first turning motor 11 to be reduced. This consequently reduces the size of the first turning motor 11, increasing its mountability on vehicles (e.g., automobiles).

It should be noted that the first controller 51 and the second controller 52 of the control device 50 may be implemented either in the same CPU or in separate CPUs. When the first controller 51 and the second controller 52 are implemented in separate CPUs, these CPUs may be mounted either on the same printed board or on separate printed boards. Implementing the first controller 51 and the second controller 52 in separate CPUs allows to reduce the possibility of both of the controllers failing due to noise, for example. Hence, even if, for example, one of the first controller 51 and the second controller 52 (e.g., the second controller 52) fails, it is possible to continue to make the front wheels 100 turn as the other of the controllers (e.g., the first controller 51) controls the driving force of the motor (e.g., the first turning motor 11) that is to be controlled by the other of the controllers (e.g., the first controller 51).

When the first controller 51 and the second controller 52 are implemented in separate CPUs that are respectively mounted on separate printed boards, these printed boards may be enclosed in separate housings. This configuration allows to reduce the possibility of both of the controllers failing due to noise or external force, for example. Thus, even in the event of a failure occurring in one of the controllers, this configuration allows to continue to make the front wheels 100 turn under the control of the other of the controllers.

### Second Embodiment

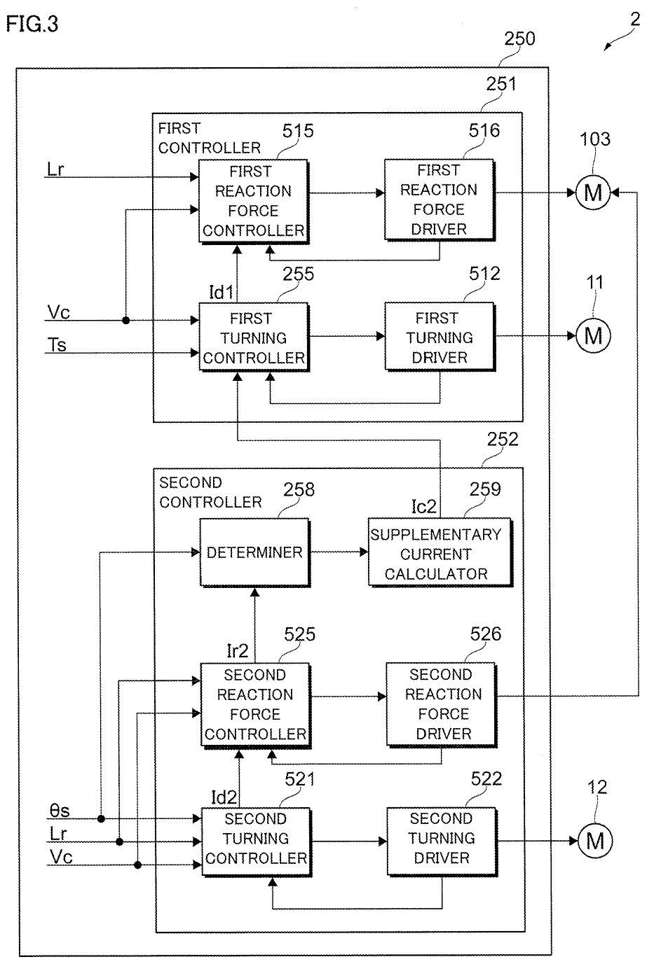

FIG. 3 shows a schematic configuration of a control device 250 according to the second embodiment.

A steering device 2 according to the second embodiment differs from the steering device 1 according to the first embodiment in its elements corresponding to the determiner 518 and the supplementary current calculator 519 of the control device 50 of the steering device 1. Below a description will be given of the differences from the steering device 1 according to the first embodiment. The same structures and functions between the steering device 1 according to the first embodiment and the steering device 2 according to the second embodiment are denoted by the respective same reference numerals and detailed description thereof have been be omitted.

The control device 250 of the steering device 2 includes a first controller 251 capable of controlling driving of the first turning motor 11 and the reaction force motor 103, and a second controller 252 controlling driving of the second turning motor 12 and the reaction force motor 103.

The first controller 251 includes: a first turning controller 255 corresponding to the first turning controller 511 of the first controller 51; the first turning driver 512; the first turning current detector (not shown); the first reaction force controller 515; the first reaction force driver 516; and the first reaction force current detector (not shown). However, unlike the first controller 51 according to the first embodiment, the first controller 251 does not include the determiner 518 and the supplementary current calculator 519 that are included in the first controller 51.

The second controller 252 includes a determiner 258 and a supplementary current calculator 259, in addition to the elements included in the second controller 52 according to the first embodiment.

The determiner 258 determines whether the driving force of the second turning motor 12 is insufficient to move the rack shaft 108 (whether there is insufficient output). The determiner 258 determines whether there is insufficient output on the basis of the steering angle θs and the second reaction force current Ir2. When rotation of the steering shaft 102 according to the second reaction force current Ir2 does not fully reach the steering angle θs detected by the steering detection device 106, the determiner 258 determines that there is insufficient output. For example, when a value obtained by subtracting an absolute value of a rotation angle θr2 of the steering shaft 102 according to the second reaction force current Ir2 from an absolute value of the steering angle θs is larger than a predetermined angle θ0 (|θs|−|θr2|>θ0), the determiner 258 determines that there is insufficient output.

When the determiner 258 determines that there is insufficient output, the supplementary current calculator 259 calculates a supplementary current Ic2 for compensating for the insufficiency of force by the driving force of the first turning motor 11. The supplementary current calculator 259 calculates the supplementary current Ic2 according to an angle difference Δθ2 that is a difference between the steering angle θs detected by the steering detection device 106 and the rotation angle θr2 of the steering shaft 102 according to the second reaction force current Ir2. The supplementary current calculator 259 obtains the angle difference Δθ2 by subtracting the rotation angle θr2 from the steering angle θs (Δθ2=θs−θr2) and calculates the supplementary current Ic2 by substituting the obtained angle difference Δθ2 into a control map or a calculation formula defining a relationship between the angle difference Δθ2 and the supplementary current Ic2. By way of example, the control map or the calculation formula may be set such that the supplementary current Ic2 is positive when the angle difference Δθ2 is positive, the supplementary current Ic2 is negative when the angle difference Δθ2 is negative, and an absolute value of the supplementary current Ic2 increases with increase in an absolute value of the angle difference Δθ2.

The supplementary current calculator 259 outputs the calculated supplementary current Ic2 to the first turning controller 255 of the first controller 251.

Upon receipt of the supplementary current Ic2 from the supplementary current calculator 259 of the second controller 252, the first turning controller 255 sets the supplementary current Ic2 as the first turning current Id1.

Similarly to the first controller 51, the above configured first controller 251 is capable of controlling the first turning motor 11 on the basis of the steering torque Ts detected by the steering detection device 106, and is capable of controlling the reaction force motor 103 on the basis of the first turning current Id1 as the control amount for controlling the first turning motor 11.

Meanwhile, similarly to the second controller 52, the second controller 252 controls the second turning motor 12 on the basis of the steering angle θs detected by the steering detection device 106, and controls the reaction force motor 103 on the basis of the second turning current Id2 as the control amount for controlling the second turning motor 12. Also on the basis of the steering angle θs detected by the steering detection device 106, the second controller 252 determines whether there is insufficient output from the second turning motor 12 and sets the supplementary current Ic2 to be supplied to the first turning motor 11. As such, on the basis of the steering angle θs detected by the steering detection device 106, the second controller 252 sets the control amount for controlling the first turning motor 11.

During an SBW operation in a normal state, the above configured steering device 2 according to the second embodiment performs control such that the second controller 252 drives the second turning motor 12, which is an example of the to-be-controlled motor and is to be controlled by the second controller 252. Specifically, each element of the second controller 252, such as the second turning controller 521, performs each processing described above at predetermined time intervals (e.g., every 1 millisecond). When the driving force of the second turning motor 12 is insufficient as a force to be applied to the rack shaft 108, the first controller 251 in the steering device 2 receives information on the supplementary current Ic2 from the second controller 252 and performs control to drive the first turning motor 11, which is the motor to be controlled by the first controller 251. Specifically, each element of the first controller 251, such as the first turning controller 255, the first turning driver 512, and the first turning current detector, performs each processing when the first controller 251 receives information on the supplementary current Ic2 from the second controller 252. Note that the above “normal state” refers to a state in which the driving force of the second turning motor 12 is sufficient as a force to be applied to the rack shaft 108. The state in which the driving force of the second turning motor 12 is sufficient as a force to be applied to the rack shaft 108 refers to a state in which the rack shaft 108 can be moved by the driving force of the second turning motor 12 such that the front wheels 100 turn by a turning angle according to the steering angle θs of the steering wheel 101.

In other words, the steering device 2 is configured such that when the driving force of the second turning motor 12, which is one of the first turning motor 11 and the second turning motor 12, is sufficient as a force to be applied to the rack shaft 108, the second controller 252 controlling driving of the second turning motor 12 drives the second turning motor 12. Also, the steering device 2 is configured such that when the driving force of the second turning motor 12 is insufficient as a force to be applied to the rack shaft 108, the first controller 251 drives the first turning motor 11 in addition to driving of the second turning motor 12.

As such, when the driving force of the second turning motor 12 is sufficient as a force to be applied to the rack shaft 108 according to the steering angle θs, or in other words when the determiner 258 does not determine that there is insufficient output, the steering device 2 according to the second embodiment performs control such that the rack shaft 108 is moved by the driving force of the second turning motor 12 under the control of the second controller 252. On the other hand, when the driving force of the second turning motor 12 is insufficient as a force to be applied to the rack shaft 108, the steering device 2 moves the rack shaft 108 by applying the driving force of the first turning motor 11 thereto in addition to the driving force of the second turning motor 12. This minimizes situations where the front wheels 100 are turned by use of the driving force of both the first turning motor 11 and the second turning motor 12, even though the configuration allows the front wheels 100 to be turned by use of the multiple motors of the first turning motor 11 and the second turning motor 12. This, in turn, suppresses control interference.

The determiner 258 of the second controller 252 determines whether the driving force of the second turning motor 12 is insufficient with reference to the steering angle θs, which is the basis for the second controller 252 to control the second turning motor 12, and the second reaction force current Ir2. Thus, the steering device 2 according to the second embodiment only activates the second controller 252 when the driving force of the second turning motor 12 can make the front wheels 100 turn by a desired angle. This reduces load on the control device 250.

The configuration in which the driving force of the first turning motor 11 compensates for any insufficient output of the driving force of the second turning motor 12, as used in the steering device 2 according to the present embodiment, allows an output capacity of the second turning motor 12 to be reduced. This consequently reduces the size of the second turning motor 12, increasing its mountability on vehicles (e.g., automobiles).

### Third Embodiment

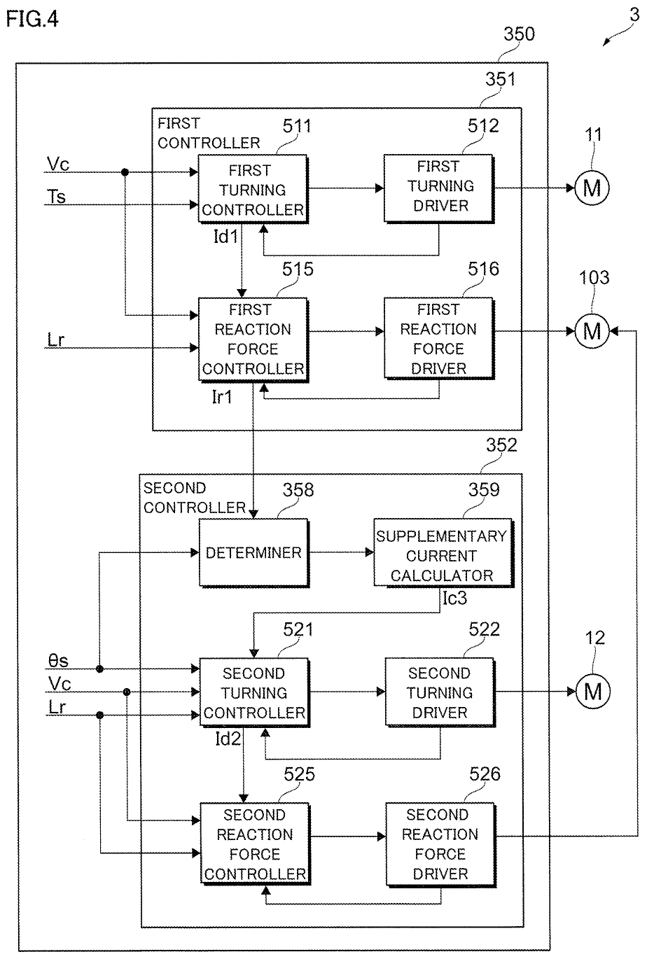

FIG. 4 shows a schematic configuration of a control device 350 according to the third embodiment.

A steering device 3 according to the third embodiment differs from the steering device 1 according to the first embodiment in its elements corresponding to the determiner 518 and the supplementary current calculator 519 of the control device 50 according to the first embodiment. Below a description will be given of the differences from the steering device 1 according to the first embodiment. The same structures and functions between the steering device 1 according to the first embodiment and the steering device 3 according to the third embodiment are denoted by the respective same reference numerals and detailed description thereof have been be omitted.

The control device 350 of the steering device 3 includes a first controller 351 controlling driving of the first turning motor 11 and the reaction force motor 103, and a second controller 352 capable of controlling driving of the second turning motor 12 and the reaction force motor 103.

Similarly to the first controller 51, the first controller 351 includes the first turning controller 511, the first turning driver 512, the first turning current detector (not shown), the first reaction force controller 515, the first reaction force driver 516, and the first reaction force current detector (not shown). However, unlike the first controller 51 according to the first embodiment, the first controller 351 does not include the determiner 518 and the supplementary current calculator 519 that are included in the first controller 51.

The second controller 352 includes a determiner 358 and a supplementary current calculator 359, in addition to the elements included in the second controller 52 according to the first embodiment.

The determiner 358 according to the third embodiment determines whether the driving force of the first turning motor 11 is insufficient to move the rack shaft 108 (whether there is insufficient output). The determiner 358 determines whether there is insufficient output on the basis of the steering angle θs and the first reaction force current Ir1. When rotation of the steering shaft 102 according to the first reaction force current Ir1 does not fully reach the steering angle θs detected by the steering detection device 106, the determiner 358 determines that there is insufficient output. For example, when a value obtained by subtracting an absolute value of a rotation angle θr1 of the steering shaft 102 according to the first reaction force current Ir1 from an absolute value of the steering angle θs is larger than a predetermined angle θ0 (|θs|−|θr1|>θ0), the determiner 358 determines that there is insufficient output.

When the determiner 358 determines that there is insufficient output, the supplementary current calculator 359 calculates a supplementary current Ic3 for compensating for the insufficiency of force by the driving force of the second turning motor 12.

The supplementary current calculator 359 calculates the supplementary current Ic3 according to an angle difference Δθ1 that is a difference between the steering angle θs detected by the steering detection device 106 and the rotation angle θr1 of the steering shaft 102 according to the first reaction force current Ir1. The supplementary current calculator 359 obtains the angle difference Δθ1 by subtracting the rotational angle θr1 from the steering angle θs (Δθ1=θs−θr1) and calculates the supplementary current Ic3 by substituting the obtained angle difference Δθ1 into a control map or a calculation formula defining a relationship between the angle difference Δθ1 and the supplementary current Ic3. By way of example, the control map or the calculation formula defining a relationship between the angle difference 401 and the supplementary current Ic3 may define a similar relationship to that in the control map explained in the second embodiment. That is, by way of example, the control map or the calculation formula may be set such that the supplementary current Ic3 is positive when the angle difference Δθ1 is positive, the supplementary current Ic3 is negative when the angle difference 401 is negative, and an absolute value of the supplementary current Ic3 increases with increase in an absolute value of the angle difference Δθ1.

The supplementary current calculator 359 outputs the calculated supplementary current Ic3 to the second turning controller 521 of the second controller 352.

Upon receipt of the supplementary current Ic3 from the supplementary current calculator 359, the second turning controller 521 sets the supplementary current Ic3 as the second turning current Id2.

Similarly to the first controller 51, the above configured first controller 351 controls the first turning motor 11 on the basis of the steering torque Ts detected by the steering detection device 106, and controls the reaction force motor 103 on the basis of the first turning current Id1 as the control amount for controlling the first turning motor 11. As such, the first controller 351 controls the first turning motor 11 and the reaction force motor 103 on the basis of the steering torque Ts detected by the steering detection device 106.

Meanwhile, similarly to the second controller 52, the second controller 352 is capable of controlling the second turning motor 12 on the basis of the steering angle θs detected by the steering detection device 106, and is capable of controlling the reaction force motor 103 on the basis of the second turning current Id2 as the control amount for controlling the second turning motor 12. Also on the basis of the steering angle θs detected by the steering detection device 106, the second controller 352 determines whether there is insufficient output from the first turning motor 11 and sets the supplementary current Ic3 to be supplied to the second turning motor 12. As such, on the basis of the steering angle θs detected by the steering detection device 106, the second controller 352 sets the control amount for controlling the second turning motor 12.

During an SBW operation in a normal state, the above configured steering device 3 according to the third embodiment performs control such that the first controller 351 drives the first turning motor 11, which is the motor to be controlled by the first controller 351. Meanwhile, the determiner 358 of the second controller 352 determines whether the driving force of the first turning motor 11 is insufficient as a force to be applied to the rack shaft 108. When the driving force of the first turning motor 11 is insufficient as a force to be applied to the rack shaft 108, the second turning controller 521 in the steering device 3 receives information on the supplementary current Ic3 from the supplementary current calculator 359 of the second controller 252 and performs control to drive the second turning motor 12, which is the motor to be controlled by the second controller 352.

As such, when the driving force of the first turning motor 11 is sufficient as a force to be applied to the rack shaft 108 according to the steering torque Ts, or in other words when the determiner 358 does not determine that there is insufficient output, the steering device 3 according to the third embodiment performs control such that the rack shaft 108 is moved by the driving force of the first turning motor 11 under the control of the first controller 351. On the other hand, when the driving force of the first turning motor 11 is insufficient as a force to be applied to the rack shaft 108, the steering device 3 moves the rack shaft 108 by applying the driving force of the second turning motor 12 thereto in addition to the driving force of the first turning motor 11. This minimizes situations where the front wheels 100 are turned by use of the driving force of both the first turning motor 11 and the second turning motor 12, even though the configuration allows the front wheels 100 to be turned by use of the multiple motors of the first turning motor 11 and the second turning motor 12. This, in turn, suppresses control interference.

During an SBW operation, the determiner 358 in the second controller 352 determines whether the driving force of the first turning motor 11 is insufficient on the basis of the steering angle θs and the first reaction force current Ir1. Thus, in the steering device 3 according to the third embodiment, when the driving force of the first turning motor 11 is sufficient to make the front wheels 100 turn by a desired angle, only the determiner 358 is activated in the second controller 352, while the first controller 351 is activated to control driving of the first turning motor 11 and the reaction force motor 103. This reduces load on the control device 350 as compared to when both of the first controller 351 and the second controller 352 are activated to drive the first turning motor 11 and the second turning motor 12 to thereby move the rack shaft 108.

The steering device 3 also allows to reduce an output capacity of the first turning motor 11 and to reduce the size of the first turning motor 11, similarly to the steering device 1 according to the above first embodiment.

### Fourth Embodiment

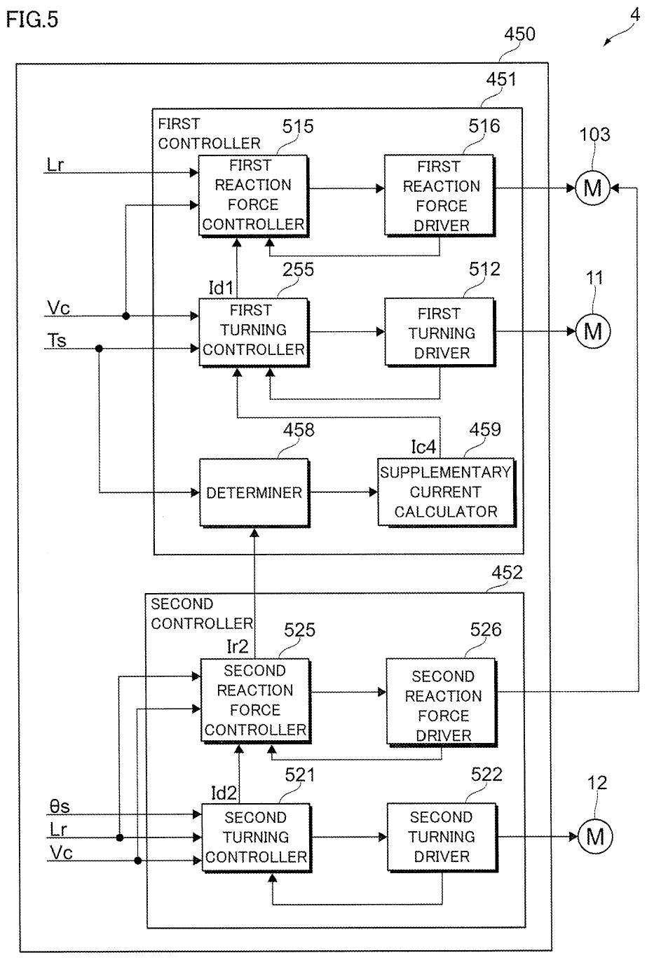

FIG. 5 shows a schematic configuration of a control device 450 according to the fourth embodiment.

A steering device 4 according to the fourth embodiment differs from the steering device 2 according to the second embodiment in its elements corresponding to the determiner 258 and the supplementary current calculator 259 of the control device 250 according to the second embodiment. Below a description will be given of the differences from the steering device 2 according to the second embodiment. The same structures and functions between the steering device 2 according to the second embodiment and the steering device 4 according to the fourth embodiment are denoted by the respective same reference numerals and detailed description thereof have been be omitted.

The control device 450 of the steering device 4 includes a first controller 451 capable of controlling driving of the first turning motor 11 and the reaction force motor 103, and a second controller 452 controlling driving of the second turning motor 12 and the reaction force motor 103.

Similarly to the first controller 251 according to the second embodiment, the first controller 451 includes: the first turning controller 255; the first turning driver 512; the first turning current detector (not shown); the first reaction force controller 515; the first reaction force driver 516; and the first reaction force current detector (not shown). The first controller 451 further includes a determiner 458 and a supplementary current calculator 459.

Unlike the second controller 252 according to the second embodiment, the second controller 452 does not include the determiner 258 and the supplementary current calculator 259 that are included in the second controller 252.

The determiner 458 according to the fourth embodiment determines whether the driving force of the second turning motor 12 is insufficient to move the rack shaft 108 (whether there is insufficient output). The determiner 458 determines whether there is insufficient output on the basis of the steering torque Ts and the second reaction force current Ir2. The determiner 458 determines that there is insufficient output when the torsion of the steering shaft 102 according to the steering torque Ts is not fully eliminated by rotation of the steering shaft 102 caused by the second reaction force current Ir2. By way of example, when a value obtained by subtracting an absolute value of motor torque Tr2 according to the second reaction force current Ir2 from an absolute value of the steering torque Ts is larger than predetermined torque T0 (|Ts|−|Tr2|>T0), the determiner 458 determines that there is insufficient output.

When the determiner 458 determines that there is insufficient output, the supplementary current calculator 459 calculates a supplementary current Ic4 for compensating for the insufficiency of force by the driving force of the first turning motor 11.

The supplementary current calculator 459 calculates the supplementary current Ic4 according to a torque difference ΔT2 that is a difference between the steering torque Ts detected by the steering detection device 106 and the motor torque Tr2 according to the second reaction force current Ir2. The supplementary current calculator 459 obtains the torque difference ΔT2 by subtracting the motor torque Tr2 from the steering torque Ts (ΔT2=Ts−Tr2), and calculates the supplementary current Ic4 by substituting the obtained torque difference ΔT2 into a control map or a calculation formula defining a relationship between the torque difference ΔT2 and the supplementary current Ic4. By way of example, the control map or the calculation formula defining a relationship between the torque difference ΔT2 and the supplementary current Ic4 may define a similar relationship to that in the control map explained in the first embodiment. That is, by way of example, the control map or the calculation formula may be set such that the supplementary current Ic4 is positive when the torque difference ΔT2 is positive, the supplementary current Ic4 is negative when the torque difference ΔT2 is negative, and an absolute value of the supplementary current Ic4 increases with increase in an absolute value of the torque difference ΔT2.

The supplementary current calculator 459 outputs the calculated supplementary current Ic4 to the first turning controller 255 of the first controller 451.

Upon receipt of the supplementary current Ic4 from the supplementary current calculator 459, the first turning controller 255 sets the supplementary current Ic4 as the first turning current Id1.

Similarly to the first controller 251, the above configured first controller 451 is capable of controlling the first turning motor 11 on the basis of the steering torque Ts detected by the steering detection device 106, and is capable of controlling the reaction force motor 103 on the basis of the first turning current Id1 as the control amount for controlling the first turning motor 11. As such, the first controller 451 is capable of controlling the first turning motor 11 and the reaction force motor 103 on the basis of the steering torque Ts detected by the steering detection device 106. Also on the basis of the steering torque Ts detected by the steering detection device 106, the first controller 451 determines whether there is insufficient output from the second turning motor 12 and sets the supplementary current Ic4 to be supplied to the first turning motor 11. As such, on the basis of the steering torque Ts detected by the steering detection device 106, the first controller 451 sets the control amount for controlling the first turning motor 11.

Meanwhile, similarly to the second controller 252, the second controller 452 controls the second turning motor 12 on the basis of the steering angle θs detected by the steering detection device 106, and controls the reaction force motor 103 on the basis of the second turning current Id2 as the control amount for controlling the second turning motor 12.

During an SBW operation in a normal state, the above configured steering device 4 according to the fourth embodiment performs control such that the second controller 452 drives the second turning motor 12, which is the motor to be controlled by the second controller 452. Meanwhile, the determiner 458 of the first controller 451 determines whether the driving force of the second turning motor 12 is insufficient as a force to be applied to the rack shaft 108. When the driving force of the second turning motor 12 is insufficient as a force to be applied to the rack shaft 108, the first turning controller 255 in the steering device 4 receives information on the supplementary current Ic4 from the supplementary current calculator 459 of the first controller 451 and performs control to drive the first turning motor 11, which is the motor to be controlled by the first controller 451.

As such, when the driving force of the second turning motor 12 is sufficient as a force to be applied to the rack shaft 108 according to the steering torque θs, or in other words when the determiner 458 does not determine that there is insufficient output, the steering device 4 according to the fourth embodiment performs control such that the rack shaft 108 is moved by the driving force of the second turning motor 12 under the control of the second controller 452. On the other hand, when the driving force of the second turning motor 12 is insufficient as a force to be applied to the rack shaft 108, the steering device 4 moves the rack shaft 108 by applying the driving force of the first turning motor 11 thereto in addition to the driving force of the second turning motor 12. This minimizes situations where the front wheels 100 are turned by use of the driving force of both the first turning motor 11 and the second turning motor 12, even though the configuration allows the front wheels 100 to be turned by use of the multiple motors of the first turning motor 11 and the second turning motor 12. This, in turn, suppresses control interference.

During an SBW operation, the determiner 458 in the first controller 451 determines whether the driving force of the second turning motor 12 is insufficient on the basis of the steering torque Ts and the second reaction force current Ir2. Thus, in the steering device 4 according to the fourth embodiment, when the driving force of the second turning motor 12 is sufficient to make the front wheels 100 turn by a desired angle, only the determiner 458 is activated in the first controller 451, while the second controller 452 is activated to control driving of the second turning motor 12 and the reaction force motor 103. This reduces load on the control device 450 as compared to when both of the first controller 451 and the second controller 452 are activated to drive the first turning motor 11 and the second turning motor 12 to thereby move the rack shaft 108.

The steering device 4 also allows to reduce an output capacity of the second turning motor 12 and to reduce the size of the second turning motor 12, similarly to the steering device 2 according to the above second embodiment.

### Fifth Embodiment

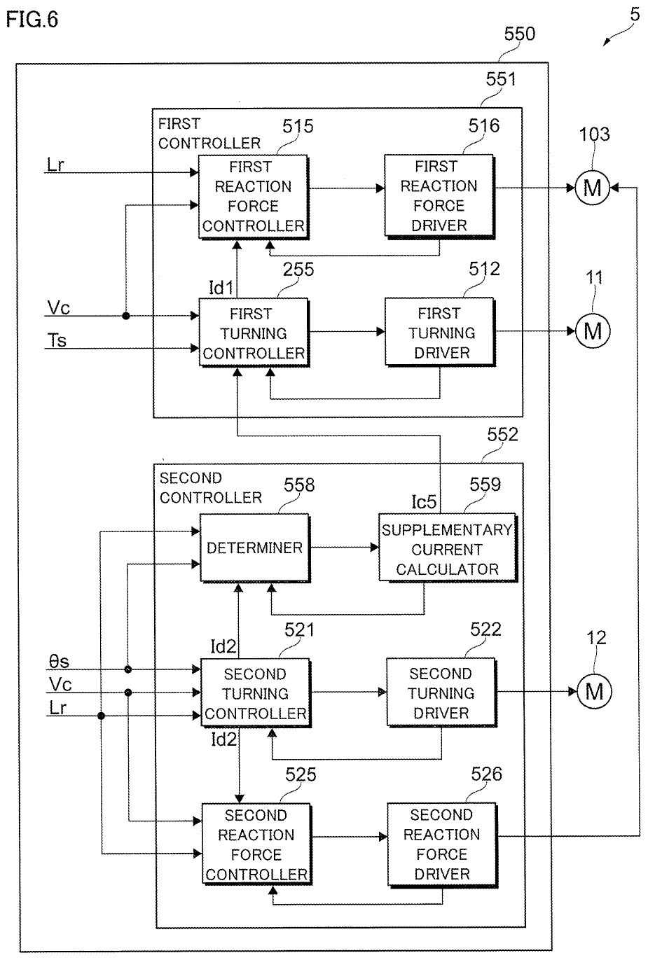

FIG. 6 shows a schematic configuration of a control device 550 according to the fifth embodiment.

A steering device 5 according to the fifth embodiment differs from the steering device 2 according to the second embodiment in its elements corresponding to the determiner 258 and the supplementary current calculator 259 of the control device 250 according to the second embodiment. Below a description will be given of the differences from the steering device 2 according to the second embodiment. The same structures and functions between the steering device 2 according to the second embodiment and the steering device 5 according to the fifth embodiment are denoted by the respective same reference numerals and detailed description thereof have been be omitted.

The control device 550 of the steering device 5 includes a first controller 551 capable of controlling driving of the first turning motor 11 and the reaction force motor 103, and a second controller 552 controlling driving of the second turning motor 12 and the reaction force motor 103.

The second controller 552 includes a determiner 558 and a supplementary current calculator 559. The determiner 558 determines whether there is insufficient output from the driving force of the second turning motor 12. When the determiner 558 determines that there is insufficient output, the supplementary current calculator 559 calculates a supplementary current Ic5 for compensating for the insufficiency of force by the driving force of the first turning motor 11.

The determiner 558 determines whether there is insufficient output on the basis of the steering angle θs detected by the steering detection device 106, the rack position Lr detected by the position detection device 109, and the second turning current Id2. The determiner 558 obtains an estimated rack position Lre that is the sum of the rack position Lr detected by the position detection device 109 and a movement amount of the rack shaft 108 caused by the second turning current Id2, and when the estimated rack position Lre does not fully reach a target rack position Lrt according to the steering angle θs detected by the steering detection device 106, the determiner 558 determines that there is insufficient output. By way of example, when a value obtained by subtracting an absolute value of the estimated rack position Lre from an absolute value of the target rack position Lrt is larger than a predetermined value Lr0 (|Lrt|−|Lre|>Lr0), the determiner 558 determines that there is insufficient output.

When the determiner 558 determines that there is insufficient output, the supplementary current calculator 559 calculates a supplementary current Ic5 for compensating for the insufficiency of force by the driving force of the first turning motor 11. The supplementary current calculator 559 calculates the supplementary current Ic5 according to a position difference ΔLr that is a difference between the target rack position Lrt and the estimated rack position Lre. The supplementary current calculator 559 obtains the position difference ΔLr by subtracting the estimated rack position Lre from the target rack position Lrt (ΔLr=Lrt−Lre), and calculates the supplementary current Ic5 by substituting the obtained position difference ΔLr into a control map or a calculation formula defining a relationship between the position difference ΔLr and the supplementary current Ic5. By way of example, the control map or the calculation formula may be set such that the supplementary current Ic5 is positive when the position difference ΔLr is positive, the supplementary current Ic5 is negative when the position difference ΔLr is negative, and an absolute value of the supplementary current Ic5 increases with increase in an absolute value of the position difference ΔLr.

The supplementary current calculator 559 outputs the calculated supplementary current Ic5 to the first turning controller 255 of the first controller 551.

Upon receipt of the supplementary current Ic5 from the supplementary current calculator 559 of the second controller 552, the first turning controller 255 sets the supplementary current Ic5 as the first turning current Id1.

Similarly to the first controller 251, the above configured first controller 551 is capable of controlling the first turning motor 11 on the basis of the steering torque Ts detected by the steering detection device 106, and is capable of controlling the reaction force motor 103 on the basis of the first turning current Id1 as the control amount for controlling the first turning motor 11.

Meanwhile, similarly to the second controller 252, the second controller 552 controls the second turning motor 12 on the basis of the steering angle θs detected by the steering detection device 106, and controls the reaction force motor 103 on the basis of the second turning current Id2 as the control amount for controlling the second turning motor 12. Also on the basis of the steering angle θs detected by the steering detection device 106, the second controller 552 determines whether there is insufficient output from the second turning motor 12 and sets the supplementary current Ic5 to be supplied to the first turning motor 11. As such, on the basis of the steering angle θs detected by the steering detection device 106, the second controller 552 sets the control amount for controlling the first turning motor 11.

During an SBW operation in a normal state, the above configured steering device 5 according to the fifth embodiment performs control such that the second controller 552 drives the second turning motor 12, which is the motor to be controlled by the second controller 552. When the driving force of the second turning motor 12 is insufficient as a force to be applied to the rack shaft 108, the first controller 251 in the steering device 5 receives information on the supplementary current Ic5 from the second controller 552 and performs control to drive the first turning motor 11, which is the motor to be controlled by the first controller 251. This minimizes situations where the front wheels 100 are turned by use of the driving force of both the first turning motor 11 and the second turning motor 12, even though the configuration allows the front wheels 100 to be turned by use of the multiple motors of the first turning motor 11 and the second turning motor 12. This, in turn, suppresses control interference.

The determiner 558 of the second controller 552 determines whether the driving force of the second turning motor 12 is insufficient with reference to the steering angle θs, which is the basis for the second controller 552 to control the second turning motor 12, the rack position Lr, and the second turning current Id2. Thus, the steering device 5 according to the fifth embodiment only activates the second controller 552 when the driving force of the second turning motor 12 can make the front wheels 100 turn by a desired angle. This reduces load on the control device 550.

The steering device 5 also allows to reduce an output capacity of the second turning motor 12 and to reduce the size of the second turning motor 12, similarly to the steering device 2 according to the above second embodiment.

### REFERENCE SIGNS LIST

1, 2, 3, 4, 5 Steering device
11 First turning motor
12 Second turning motor
103 Reaction force motor
50, 250, 350, 450, 550 Control device
51, 251, 351, 451, 551 First controller
52, 252, 352, 452, 552 Second controller
518, 258, 358, 458, 558 Determiner
519, 259, 359, 459, 559 Supplementary current calculator

1. A steering device comprising:
a first motor and a second motor each configured to apply a force for moving a turning shaft for turning wheels of a vehicle;
a third motor configured to apply a reaction force to steering of a steering member;
a first controller configured to control driving of the first motor and the third motor on a basis of steering torque of the steering member; and
a second controller configured to control driving of the second motor on a basis of a steering angle of the steering member, wherein
in a state where the steering member and the wheels are not mechanically connected, when a driving force of the first motor is sufficient as a force to be applied to the turning shaft, the first controller drives the first motor, and when the driving force of the first motor is insufficient as a force to be applied to the turning shaft, the second controller drives the second motor in addition the first motor being driven by the first controller,
the first controller is configured to control the third motor on a basis of a position of the turning shaft and a control amount for controlling the first motor, and
the steering device further comprises a determiner configured to determine whether the driving force of the first motor is sufficient as a force to be applied to the turning shaft, on a basis of steering torque of the steering member and a control amount for controlling the third motor.

2. A steering device comprising:
a first motor and a second motor each configured to apply a force for moving a turning shaft for turning wheels of a vehicle;
a third motor configured to apply a reaction force to steering of a steering member;
a first controller configured to control driving of the first motor on a basis of steering torque of the steering member; and
a second controller configured to control driving of the second motor and the third motor on a basis of a steering angle of the steering member, wherein
in a state where the steering member and the wheels are not mechanically connected, when a driving force of the second motor is sufficient as a force to be applied to the turning shaft, the second controller drives the second motor, and when the driving force of the second motor is insufficient as a force to be applied to the turning shaft, the first controller drives the first motor in addition the second motor being driven by the second controller,
the second controller is configured to control the third motor on a basis of a position of the turning shaft and a control amount for controlling the second motor, and
the steering device further comprises a determiner configured to determine whether the driving force of the second motor is sufficient as a force to be applied to the turning shaft, on a basis of a steering angle of the steering member and a control amount for controlling the third motor.
